(19) United States
(12) Patent Application Publication
(10) Pub. No.: US 2013/0066536 A1
(43) Pub. Date: Mar. 14, 2013

(54) SENSOR OUTPUT MODIFIER

(71) Applicant: Keith M. Rumbel, Dungog (AU)

(72) Inventors: Derek R. Watkins, Dungog (AU); Bruce R. Watkins, Dungog (AU); Keith M. Rumbel, Dungog (AU)

(73) Assignee: GAS TEK SOLUTIONS PTY LTD., Dungog, New South Wales (AU)

(21) Appl. No.: 13/144,245

(22) PCT Filed: Jan. 12, 2010
(86) PCT No.: PCT/AU10/00019

§ 371 Date: Jan. 24, 2012

(30) Foreign Application Priority Data
Jan. 12, 2009 (AU) 2009900081

(51) Int. Cl. F02D 41/26; F02D 41/38

(52) U.S. Cl. 701/104

(57) ABSTRACT

A modification to the “gas-topping” invention disclosed in WO 2008/064415 is disclosed in this specification. The modification involves measuring a sensor input such as that provided by a diesel engine diesel fuel rail pressure sensor (5) to thereby provide a signal indicative of fuel flow rate, modifying that signal by a signal modifier (3), and substituting the modified signal for the original unmodified signal in an engine electronic control unit (7). The result is that there is no increase in engine power relative to that produced without “gas-topping” so that substantially all the benefits of “gas-topping” are captured in decreased fuel consumption and not to provided in the form of increased engine power.

### FIELD OF THE INVENTION

The present invention relates to a method and system of controlling fuel injection in diesel fuel engines and, in particular, to a sensor output modifier for use therewith.

The invention has been developed primarily for use with vehicles having diesel fuel engines using diesel fuel and having combustible gas injected therein and will be described hereinafter with reference to this application. However, it will be appreciated that the invention is not limited to this particular field of use and is applicable to any diesel fuel engine using any suitable fuel and having combustible gas injected therein.

### BACKGROUND ART

It is known that injecting small amounts of a combustible gas into the air intake stream of a diesel engine increases the efficiency of combustion of the diesel fuel. This process is sometimes known as “gas-topping”. This consequently provides a power increase for the same diesel fuel use by the addition of only relatively small amounts of a combustible gas. PCT Patent Publication Number WO 2008/064415 discloses a system and method of injecting LPG or other combustible gas into a diesel fuel engine where the combustible gas is injected in the amount of 0.2% to 0.6% of the air intake.

The addition of the combustible gas to the air intake stream significantly improves the combustion efficiency of the diesel fuel in the engine and also significantly reduces particulate matter and other emissions from the diesel engines.

The prior art system provides increased engine productivity with the addition of a relatively small amount of combustible gas. This efficiency increase can typically result in power gains of 20% to 30% for the diesel fuel engine as opposed to running the engine without the combustible gas injected in the engine.

Also in the prior art, it is known to inject LPG into the air intake stream of a diesel fuel engine by other methods and systems. However, these are unmetered or unregulated devices that inject typically significantly more than 0.6% LPG gas into the air intake stream. It appears that these other known systems offer only minimal efficiency gains in the operation of the diesel fuel engines. Further, prior art systems are known to damage the diesel fuel engines when the percentage of LPG gas is increased to a too great amount.

### BACKGROUND OF THE INVENTION

Gas topping apparatus of the general type disclosed in the above mentioned PCT specification was installed in garbage trucks operated in a New South Wales country town. After the apparatus has been in operation for a period of time no fuel savings were achieved, contrary to expectations and experience elsewhere. This mystifying result was investigated and the municipal records examined which indicated that the time taken for the garbage run after the apparatus had been installed was substantially reduced relative to the time take prior to the installation of the apparatus. This investigation enabled the understanding to be achieved that the gas topping resulted in increase power which the garbage truck operators utilised to drive their trucks faster and thereby finish their working shift sooner.

### GENESIS OF THE INVENTION

The genesis of the present invention is a desire to capture the benefits of gas topping in decreased fuel consumption rather than increased engine power (which merely enables employees to finish their allocated tasks sooner, rather than to provide any financial benefit to the employer). This desire was realised by providing a sensor output modifying device to modify the fuel consumption rate of a diesel engine and maintain substantially no net increase or decrease in engine power output over that provided by the engine without the combustible gas.

### SUMMARY OF THE INVENTION

According to a first aspect of the present invention there is provided a method of controlling injection of fuel in a diesel fuel engine configured to receive a combustible gas in a diesel engine air intake, said method comprising the steps of measuring a sensor input signal indicative of a fuel flow rate, modifying said sensor input signal to provide a signal indicative of a modified fuel injection rate such that said diesel engine provides substantially no power gain over said diesel engine without injection of said combustible gas.

According to second aspect of the present invention there is provided a sensor output modifier for controlling injection of fuel in a diesel fuel engine configured to receive a combustible gas in a diesel engine air intake stream, said sensor output modifier comprising an input configured to receive a sensor input signal indicative of fuel injection rates and configured to modify said sensor input signal to provide a modified output signal indicative of a modified fuel injection rate such that said diesel engine provides substantially no power gain over said diesel engine without injection of said combustible gas.

According to a third aspect of the present invention there is provided a system for controlling the rate of injection of fuel in a diesel fuel engine having a combustible gas injected into an air intake of said diesel fuel engine, said system comprising a sensor output modifier configured to receive a sensor input signal indicative of fuel injection rates and modifying said sensor input to provide an output signal indicative of a modified fuel injection rate such that said diesel engine provides substantially no power gain over said diesel engine without injection of said combustible gas.

According to another aspect of the invention there is provided a diesel fuel engine configured to operate the method according to the first aspect of the invention or comprising a sensor output modifier according to the second aspect of the invention or comprising a system according to the third aspect of the invention.

It can therefore be seen that there is advantageously provided a method of controlling injection of diesel fuel in a diesel fuel engine, a sensor output modifier, and a system for controlling injection of diesel fuel in a diesel fuel engine that advantageously removes substantially any power gain provided by the inclusion of a combustible gas in the air intake stream of the diesel engine by scaling back the amount of diesel fuel injected into the diesel engine and consumed by it.

### BRIEF DESCRIPTION OF THE DRAWINGS

Preferred embodiments of the invention will now be described, by way of example only, with reference to the accompanying drawings in which:

FIG. 1 is a schematic diagram of a system for controlling the rate of injection of diesel fuel in a diesel fuel engine according to a first preferred embodiment; and

FIG. 2 is a schematic diagram of a system for controlling the rate of injection of diesel fuel in a diesel fuel engine according to another preferred embodiment.

### DETAILED DESCRIPTION

It will be appreciated that throughout the specification like reference numerals have been used to denote like components.

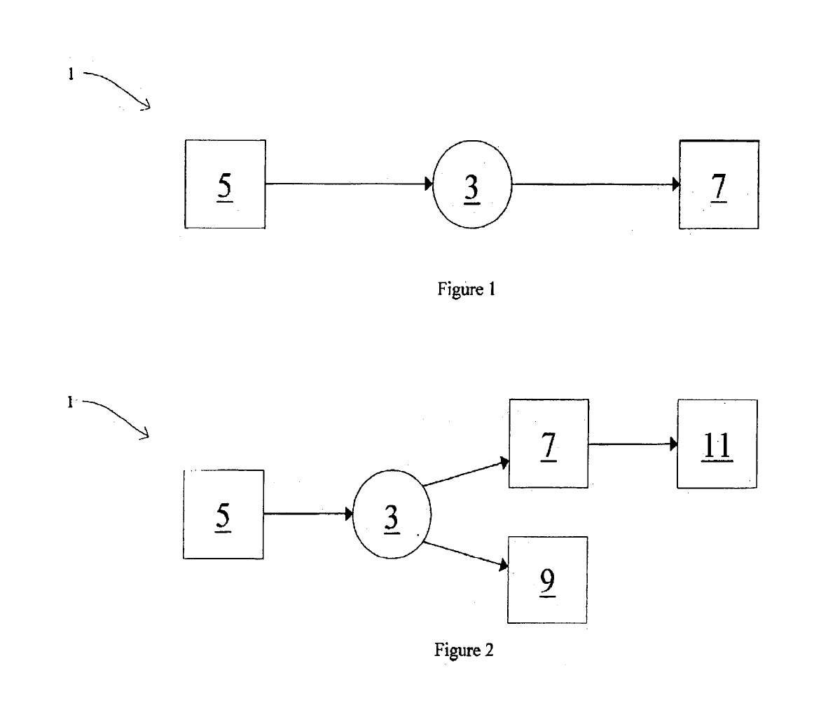

In the schematic diagram of FIG. 1, there is shown a system 1 for controlling the rate of injection of diesel fuel in a diesel fuel engine (not illustrated) of a vehicle (also not illustrated). The diesel engine is configured to receive a combustible gas in a predetermined amount via its air intake stream. Such a system is as disclosed in WO 2008/064415 referred to above, the disclosure of which is incorporated herein in its entirety by cross-reference.

As the disclosure of WO 2008/064415 indicates, the use of the combustible gas mixed in the air intake stream enhances the combustion efficiency of the diesel fuel thereby increasing the power delivered by the amount of fuel consumed. The system 1 is configured to manipulate or modify one or more sensor input signals normally received by the engine electronic control unit (ECU) 7 and being such as to cause the diesel fuel to be injected at a predetermined rate.

In the preferred embodiment of FIG. 1 a diesel fuel rail pressure sensor 5 provides a signal indicative of the diesel engine's diesel fuel rail pressure. Typically, this signal is input into the engine ECU 7 which then adjusts the fuel pressure so as to ensure a predetermined rate of delivery rate of diesel fuel is injected into the cylinders for combustion.

In the system 1 of FIG. 1, however, the additional power generated by the engine due to the combustible gas being injected into the engine air intake is removed by interception of the diesel fuel rail pressure sensor 5 output signal by a sensor signal modifier 3. The sensor signal modifier 3 receives the fuel rail pressure signal and modifies this to provide a modified output signal to the ECU 7. The modified output signal is characterised by removal of all power gain provided by injecting the combustible gas into the air intake stream so that the diesel engine provides substantially the same level of power and substantially all efficiency gains by use of the combustible gas are converted into reduced diesel fuel consumption by the diesel engine.

It will be appreciated that in some applications, it may be desirable to utilise the additional power generated by the use of the combustible gas injected into the air intake stream of the engine. In such cases, the system 1 can be disabled so that the sensor input signal 5 bypasses or is not otherwise modified by the sensor output modifier 3 so that there is no variation in the diesel fuel injection rates.

Although not illustrated, it will be appreciated that the system 1 can be installed with any diesel engine having a combustible gas injected into the air intake stream thereof. An electrical switching mechanism can be provided to allow operation of the diesel engine where the injected combustible gas is disabled and the system 1 is also disabled, and where the combustible gas injected into the air intake stream is enabled and the system 1 is either enabled to modify the fuel rail pressure signal provided to the ECU and hence reduce fuel consumption or to disable the system 1.

In the embodiment of FIG. 1, the modified output signal from the sensor signal modifier 3 is input directly into the ECU 7. However, in other embodiments of the invention (not illustrated), the sensor signal modifier can be disposed intermediate the ECU 7 and engine diesel fuel pump, for example.

It will also be appreciated that although the system 1 of FIG. 1 uses the diesel fuel rail pressure of the engine, any other preferred sensed input signal can be used as desired, although the diesel fuel rail pressure is most preferred. For example, the sensor input signal can be measured from an engine throttle position switch, engine airflow sensor, manifold air pressure or combustible gas injection rate. Of course, any preferred property from which the fuel consumption is or can be dependent upon can be modified by the sensor signal modifier 3 of the system 1.

It will be further appreciated that a plurality of sensors 5 measuring the same or different properties can be input into the sensor signal modifier 3. In such cases, the second or subsequent sensor signals input into the sensor signal modifier 3 can be used simply as validation against a primary sensed signal which would most preferably, although not illustrated, be the diesel fuel rail pressure. It will also be appreciated that the second or subsequent sensor input signals can be used also in comparison to the diesel rail pressure signal or simply as a redundancy in case of failure of other sensors 5.

The modification by the sensor signal modifier 3 of the sensor input signal provided by the sensor 5 can be as desired. For example, in the embodiment of FIG. 1 any preferred arithmetic operations can be carried out on the sensor input signal so that the sensor signal modifier 3 provides a signal which is an arithmetic manipulation of the signal received by the sensor signal modifier 3.

It can therefore be seen that the system 1 advantageously allows substantially all power and efficiency gain provided by gas-topping the diesel engine can be converted into reduced diesel fuel consumption. Optionally, the system 1 can be switched to boost the power of the engine by not reducing fuel consumption if expedient in the circumstance of use of the diesel engine.

Referring now to FIG. 2, there is shown a system 1 according to another preferred embodiment for controlling the rate of flow of injection of diesel fuel in a diesel fuel engine.

In this embodiment, the sensor output modifier 3 is a microprocessor based device configured to receive a sensor input signal from a diesel fuel line pressure sensor 5.

The sensor output modifier 3 further includes a two-way communications transceiver 9 to provide communications to and from the sensor output modifier 3 remotely. The sensor output modifier 3 provides a modified sensor output signal provided to the ECU 7. The engine ECU then provides a signal to a diesel fuel engine controller, typically in the form of a diesel fuel pump 11.

In the embodiment of FIG. 2, a vehicle having the system 1 mounted thereto has the engine power or indicative measure tested. In the case of a diesel powered land vehicle, this is achieved on a dynamometer. The output power of the engine is then measured.

The combustible gas is then injected into the air intake stream of the engine and the dynamometer again provides a power output. The difference in these power outputs provides an indication of the power provided by the additional combustion efficiency provided by use of the combustible gas injected into the air intake stream of the engine.

The sensor output modifier 3 is then configured to provide a modified sensor output to the engine ECU 7 where the modified sensor output is indicative of a fuel injection rate required to remove the power increase provided by the addition of the combustible gas in the air intake stream. That is, the diesel fuel injection rate is reduced so the engine produces the same power it would if it were not gas topped.

In this way, substantially all efficiency gains provided by injecting combustible gas into the air intake stream of an engine are returned as reduced fuel consumption as a lesser amount of diesel fuel is required to produce the same amount of engine power output.

It will be appreciated that any preferred hardware or software implementation of the system 1 can be provided to achieve the result that the power gain provided by injecting combustible gases into the air intake of an engine is converted manner into decreased fuel consumption.

The foregoing describes only two preferred embodiments of the present invention and modifications, obvious to those skilled in the art, can be made thereto without departing from the scope of the present invention. For example, the diesel fuel engine described above may use any suitable fuel as a substitute for or in combination with diesel fuel. An exemplary substitute fuel may include bio-diesel fuel or coal slurry.

In the case of the use of a coal slurry as a replacement for diesel fuel, the coal slurry produces less power when combusted than diesel fuels. The injection of the combustible gas into the air intake stream increases the power produced by the coal slurry and any additional power can be scaled back by reducing the rate of injection of the coal slurry by use of the system 1. An equivalent property to the diesel fuel rail pressure measured by sensor 5 is used with the coal slurry fuel and may include coal slurry fuel pressure. Of course, any combination of diesel fuel and/or any other suitable fuel or fuels can be used.

It will also be appreciated that the combustible gas injected into the air intake stream of the diesel engine can be any desired. Such gases include, but are not limited to, LPG, liquid or compressed natural gas, hydrogen, ethane, methane, propane, butane, hexane, heptane, pentane, acetylene, carbon monoxide, ammonia, or a combination of one or more of these and/or other combustible gases.

The term “comprising” (and its grammatical variations) as used herein is used in the inclusive sense of “including” or “having” and not in the exclusive sense of “consisting only of”.

1. A method of controlling injection of fuel in a diesel fuel engine configured to receive a combustible gas in a diesel engine air intake wherein said combustible gas is delivered at a substantially constant concentration of the engine air intake, said method comprising the steps of measuring a sensor input signal indicative of a fuel flow rate, modifying said sensor input signal to provide a signal indicative of a modified fuel injection rate such that said diesel engine provides substantially no power gain over said diesel engine without injection of said combustible gas.

2. A method according to claim 1 wherein said signal indicative of a modified fuel injection rate is communicated to an input of a diesel engine electronic control unit.

3. A method according to claim 1 wherein said signal indicative of a modified fuel injection rate is produced by an engine fuel pump.

4. A method according to claim 1 further comprising the steps of measuring diesel fuel engine power, injecting a predetermined volume of combustible gas in the air intake stream of said diesel engine and measuring power generated thereby, and determining the decrease in fuel pressure such that substantially no net increase in engine power output is provided by the injection of said combustible gas.

5. A method according to claim 1 further comprising the steps of determining the diesel fuel engine output power with and without said combustible gas injected into said engine air intake stream and modifying said sensor input signal indicative of fuel consumption to modify fuel injection rates such that said engine provides substantially no net increase in engine power output without injection of said combustible gas.

6. A method according to claim 1 wherein said sensor input signal is a measure of fuel pressure, throttle position switch, air flow, manifold air pressure or combustible gas injection rates.

7. A method according to claim 1 wherein said sensor input signal is indicative of said fuel injection rates and varies between 0 V to a predetermined voltage.

8. A method according to claim 1 further comprising the step of measuring a plurality of sensor input signals each indicative of fuel injection rates.

9. A method according to claim 8 wherein a second and any subsequent measured sensor input signal is a redundant signal or compared against a first measured sensor input signal.

10. A method according to claim 1 wherein said sensor input signal can be modified by one or more arithmetic operations.

11. A method according to claim 1 wherein said diesel engine is configured to combust diesel fuel, bio-diesel fuel or a coal slurry.

12. A sensor output modifier for controlling injection of fuel in a diesel fuel engine configured to receive a combustible gas delivered at a substantially constant concentration of the air injected in a diesel engine air intake stream, said sensor output modifier comprising an input configured to receive a sensor input signal indicative of fuel injection rates and configured to modify said sensor input signal to provide a modified output signal indicative of a modified fuel injection rate such that said diesel engine provides substantially no power gain over said diesel engine without injection of said combustible gas.

13. A sensor output modifier according to claim 12 wherein said modified output signal is configured to be provided as input to a diesel engine electronic control unit.

14. A sensor output modifier according to claim 12 wherein said modified output signal is configured to be provided directly to a diesel engine fuel pump to control the fuel injection rate to said diesel fuel engine.

15. A sensor output modifier according to claim 12 wherein said sensor input signal is measured from the fuel pressure, throttle position switch, air flow sensor, manifold air pressure or combustible gas injection rate.

16. A sensor output modifier according to claim 12 including a plurality of distinct input signals and a plurality of corresponding distinct modified output signals having a predetermined voltage range.

17. A sensor output modifier according to claim 12 wherein said diesel fuel engine is configured to combust diesel fuel, bio-diesel fuel or a coal slurry.

18. A system for controlling the rate of injection of fuel in a diesel fuel engine having a combustible gas injected into an air intake of said diesel fuel engine, said combustible gas being delivered at a substantially constant concentration of the engine intake, said system comprising a sensor output modifier configured to receive a sensor input signal indicative of fuel injection rates and modifying said sensor input to provide an output signal indicative of a modified fuel injection rate such that said diesel engine provides substantially no power gain over said diesel engine without injection of said combustible gas.

19. A diesel fuel engine configured to operate the method according to claim 1.

20. A diesel fuel engine comprising a sensor output modifier according to claim 12.

21. A diesel fuel engine comprising a system according to claim 18.
